(19) United States
(12) Patent Application Publication
(10) Pub. No.: US 2026/0294104 A1
(43) Pub. Date: Oct. 1, 2026

(54) Method of Producing One or More Laminate Boards and Laminate Board

(71) Applicant: KRONOPLUS LIMITED, Mosta (MT)

(72) Inventors: Imre NAGY, Szombathely (HU); Marco TALASZ, Siget in der Wart (AT)

(21) Appl. No.: 19/477,885

(22) PCT Filed: Apr. 22, 2024
(86) PCT No.: PCT/EP2024/060931

§ 371 Date: Oct. 23, 2025

(30) Foreign Application Priority Data
Apr. 24, 2023 (EP) 23169558.6

(51) Int. Cl. A47B 96/20; B32B 21/06

(52) U.S. Cl. CPC A47B 96/206; B32B 21/06; B32B 2250/03; B32B 2260/028; B32B 2260/046; B32B 2307/406; B32B 2307/584; B32B 2307/7246; B32B 2479/00

(57) ABSTRACT

The present invention is directed to a method of producing one or more laminate boards, the method comprising the steps: providing at least one board comprising wooden material, producing at least one board layer assembly, subjecting the at least one board layer assembly to at least one main pressing step in which the at least one board layer assembly is pressed with a main pressing pressure at a main pressing step temperature of at least 100° C., and subjecting the at least one pressed board layer assembly to a cooling step in which the at least one pressed board layer assembly is cooled from the main pressing step temperature to a pressure release temperature of 90° C. or lower while keeping the at least one pressed board layer assembly pressed substantially with the main pressing pressure. Furthermore, the present invention is also directed to a laminate board.

The present invention is directed to a method of producing one or more laminate boards and to a laminate board.

Laminate boards known from the state of the art usually comprise a board, a décor layer, and a finishing layer. The finishing layer should on the one hand protect the laminate from external influences and should furthermore provide the surface of the laminate with a desired surface gloss or mattness.

Although laminate boards with smooth finishing layers are known from the state of the art, the finishing layers of these known laminate is still not satisfactorily high enough, so that touching the surface of these laminate boards can feel uncomfortable. Furthermore, such known laminate boards are relatively vulnerable to external influences, such as scratches, acid or steam.

Moreover, no method is available yet for producing a laminate that has a very smooth and matt surface having good resistances.

Starting herefrom, it was the object of the present invention to provide a method of producing one or more laminate boards having a finishing layer with improved properties.

This object is solved by a method having the features of patent claim 1 and by a board having the features of patent claim 11. The dependent claims represent advantageous further developments.

According to the present invention, a method of producing one or more laminate boards is provided, the method comprising the following steps:
a) Providing at least one board comprising wooden material,
b) Producing at least one board layer assembly by
   applying at least one intermediate layer comprising at least one décor layer on at least one side of the at least one board and applying at least one finishing layer or at least one precursor for (the) at least one finishing layer on the at least one intermediate layer, or
   applying at least one coated or impregnated intermediate layer comprising at least one décor layer on at least one side of the at least one board, the at least one coated or impregnated intermediate layer having a coating or impregnation of (or with) at least one finishing layer or at least one precursor for at least one finishing layer,
c) Subjecting the at least one board layer assembly to at least one main pressing step in which the at least one board layer assembly is pressed with a main pressing pressure at a main pressing step temperature of at least 100° C.,
d) Subjecting the at least one (still) pressed board layer assembly to a cooling step in which the at least one pressed board layer assembly is cooled from the main pressing step temperature to a pressure release temperature (or cooling step temperature) of 90° C. or lower while keeping the at least one pressed board layer assembly pressed substantially with the main pressing pressure.

In step a), at least one board is provided, wherein the at least one board comprises wooden material. For example, the at least one board can be at least one particle boards and/or at least one fibreboard, such as a medium-density fibreboard (MDF board) or high-density fibreboard (HDF board). Both particle boards and fibreboards are pressed wood products made from wood fibres mixed with synthetic resin adhesives. The main differences are the size and type of wood fibres used in production. Fibreboards, in particular MDF boards, use fine, granular particles for a more homogeneous density, with smooth, narrow edges for strength and workability. Particleboards are made from smaller pieces of refined wood. As usual, one board of the at least one board provided in step a) can have two (opposite) sides, i.e. one first side and one second side.

In step b), at least one board layer assembly is produced. For this,
at least one intermediate layer comprising at least one décor layer is applied on at least one side of the at least one board provided in step a) and, furthermore, at least one finishing layer (or at least one precursor for at least one finishing layer) is applied on the at least one intermediate layer (already applied on the at least one side of the at least one board), or
at least one coated or impregnated intermediate layer comprising at least one décor layer is applied on at least one side of the at least one board provided in step a), the at least one coated or impregnated intermediate layer having a coating or impregnation of at least one finishing layer (or at least one precursor for at least one finishing layer).

Thus, there are two alternatives for producing the at least one board layer assembly. According to the first alternative, firstly, at least one intermediate layer (comprising at least one décor layer) is applied on at least one side of the at least one board and then at least one finishing layer (or at least one precursor for at least one finishing layer) is applied on the at least one intermediate layer (already applied on the at least one side of the at least one board). According to the second alternative, at least one intermediate layer (comprising at least one décor layer), which already has at least one finishing layer (or at least one precursor for at least one finishing layer) as a coating or impregnation, is applied on at least one side of the at least one board.

The at least one intermediate layer comprises at least one décor layer (or decorative layer) and can optionally comprise at least one balancing layer. Thus, the at least one board layer assembly comprises at least one board, at least one intermediate layer, and at least one finishing layer (or at least one precursor for a finishing layer), wherein the at least one intermediate layer comprises at least one décor layer and optionally at least one balancing layer, wherein the at least one intermediate layer is arranged on at least one side of the at least one board, and wherein at least one finishing layer (or at least one precursor for a finishing layer) is arranged on the at least one intermediate layer.

For example, in step b), the at least one board layer assembly can be produced by
applying at least one décor layer on at least one side of the at least one board and applying at least one finishing layer (or at least one precursor for at least one finishing layer) on the at least one décor layer, or
applying at least one décor layer on at least one side of the at least one board, applying at least one balancing layer on the at least one décor layer, and applying at least one finishing layer (or at least one precursor for at least one finishing layer) on the at least one balancing layer, or
applying at least one coated or impregnated décor layer on at least one side of the at least one board, the at least one coated or impregnated décor layer having a coating or impregnation of (or with) at least one finishing layer (or at least one precursor for at least one finishing layer), or
applying at least one coated or impregnated décor layer on at least one side of the at least one board, the at least one coated or impregnated décor layer having a coating or impregnation of (or with) at least one balancing layer and at least one finishing layer (or at least one precursor for at least one finishing layer).

For example, in step b), the at least one intermediate layer can be applied on one side of each of the at least one board or can be applied on both sides of each of the at least one board. In the first case, (after applying the at least one finishing layer if the at least one intermediate layer does not already have a coating or impregnation of at least one finishing layer,) one or more board layer assemblies is/are obtained each comprising one board, at least one intermediate layer arranged on one side of the board, and at least one finishing layer arranged on the at least one intermediate layer. In the second case, (after applying the at least one finishing layer if the at least one intermediate layer does not already have a coating or impregnation of at least one finishing layer,) one or more board layer assemblies is/are obtained each comprising one board, at least one first intermediate layer arranged on the first of the two sides of the board and at least one second intermediate layer arranged on the second of the two sides of the board, and at least one first finishing layer arranged on the at least one first intermediate layer and at least one second finishing layer arranged on the at least one second intermediate layer.

The at least one décor layer can preferably be at least one décor paper. In particular, common impregnated papers can be used as at least one décor paper. For example, these papers can be prepared in a two-stage impregnation process by applying aqueous solutions of melamine and/or urea resins. As the range of different decors, the range of surface weight from papers that can be used is varying.

For example, common finishing layers known from the state of the art can be used as the at least one finishing layer. For example, the at least one finishing layer is at least one polymeric layer, e.g. an acrylic layer.

It is possible that the at least one finishing layer is carried by a carrier, e.g. a PET foil. In this case, the at least one finishing layer can be applied to the at least one intermediate layer together with the carrier or by transferring the at least one layer from the carrier to the at least one intermediate layer. The carrier can be peeled off after application. It is also possible that the carrier remains underneath the finishing layer and is pressed together with it.

Furthermore, at least one precursor for the at least one finishing layer might be applied in step b), wherein the at least one precursor becomes at least one finishing layer during the at least one main pressing step. For example, the precursor for at least one finishing layer might be an (uncured) resin (e.g. present in form of a liquid), which is cured during the at least one main pressing step and thereby becomes the at least one finishing layer. According to another example, the at least one precursor for at least one finishing layer might be a liquid lacquer or a liquid varnish, which is cured during the at least one main pressing step and thereby becomes the at least one finishing layer (e.g. in form a solid lacquer layer or a solid varnish layer).

The at least one finishing layer can preferably be at least one matting layer. Accordingly, the at least one precursor for the finishing layer can preferably be at least one precursor for at least one matting layer.

In step c), the at least one board layer assembly produced in step b) is subjected to at least one main pressing step in which the at least one board layer assembly is pressed with a main pressing pressure at a main pressing step temperature of at least 100° C. (thereby laminating the at least one board layer assembly). The pressing with the main pressing pressure can be achieved, for example, by pressing the at least one board assembly between press plates in a press, e.g. a multi-stage press. Furthermore, at least one heating device can be used, for example, to heat and/or keep the at least one board layer assembly at the main pressing step temperature. If at least one precursor for at least one finishing layer is used in step b), this at least one precursor becomes the at least one finishing layer during the at least one main pressing step.

After step c), the at least one board layer assembly can also be designated as at least one laminate board.

In step d), the at least one (still) pressed board layer assembly is subjected to a cooling step in which the at least one pressed board layer assembly is cooled from the main pressing step temperature to a pressing release temperature of 90° C. or lower while keeping the at least one pressed board layer assembly pressed substantially with the main pressing pressure. Thus, the pressed board layer assembly is cooled from the main pressing step temperature to the pressure release temperature while substantially not changing the pressing pressure of step c). In other words, the cooling takes place when the at least one pressed board layer assembly is still in a pressed state without substantially lowering the pressure used in step c). Thus, the pressure acting on the at least one pressed board layer assembly during step c) is substantially not released after step c) until the cooling step ends, i.e. until the at least one pressed board layer assembly has been cooled to the pressure release temperature. When the at least one pressed board layer assembly has been cooled to the pressure release temperature, the pressing pressure can be (fully) released from the at least one board layer assembly.

The pressure release temperature can also be called cooling step temperature.

The feature that the at least one pressed board layer assembly is kept pressed substantially with the main pressing pressure means that the at least one pressed board layer assembly is kept pressed with a pressure not more than 5 kPa higher and not more than 5 kPa lower than the main pressing pressure, preferably with a pressure not more than 2 kPa higher and not more than 2 kPa lower than the main pressing pressure, more preferably with a pressure not more than 500 Pa higher and not more than 500 Pa lower than the main pressing pressure, in particular with a pressure not more than 100 Pa higher and not more than 100 Pa lower than the main pressing pressure.

Preferably, in step d), the at least one pressed board layer assembly is subjected to a cooling step in which the at least one pressed board layer assembly is cooled from the main pressing step temperature to a pressure release temperature of 90° C. or lower while keeping the at least one pressed board layer assembly pressed with the main pressing pressure.

After step d), the pressing pressure can be (or is) (fully) released from the at least one board layer assembly (e.g. in a step e) of the method, e.g. by (fully) releasing the press plates and/or (fully) opening the press used for pressing the at least one board layer assembly.

According to the present invention, after the start of step c), a release of the (pressing) pressure to a pressure substantially below the main pressing pressure takes place only after the end of step d), i.e. after the at least one pressed board layer assembly has been cooled to the pressure release temperature. In this context, a pressure substantially below the main pressing pressure means a pressure that is at least 5 kPa below the main pressing pressure, preferably a pressure that is at least 2 kPa below the main pressing pressure, more preferably a pressure that is at least 500 Pa below the main pressing pressure, in particular a pressure that is at least 100 Pa below the main pressing pressure.

Preferably, after the start of step c), a release of the (pressing) pressure to a pressure below the main pressing pressure takes place only after the end of step d), i.e. after the at least one pressed board layer assembly has been cooled to the pressure release temperature.

The cooling of the at least one pressed board layer in step d) can be conducted e.g. by using cooling device, preferably back cooling device integrated into the press.

With the method according to the present invention a laminate board with at least one finishing having improved properties can be obtained due to the main pressing step and the specific cooling step. In detail, by pressing of the at least one board layer assembly in the at least main pressing step in step c), the surface of the at least one finishing layer is smoothed and sealed resulting in the at least one finishing layer having improved properties, such as e.g. a low surface roughness, a low glossiness, and a high resistance to scratching. The cooling step in step d) ensures that the at least one finishing layer still exhibits these improved properties after releasing the pressing pressure from the at least one board layer assembly (or the at least one laminate board) as explained in the following.

In the methods according to the prior art, the cooling of the board layer assembly after the main pressing step is always conducted after the pressing pressure has been fully released from the board layer assembly. Thus, in these prior art methods, the pressing pressure is released when the board layer assembly is still at the high temperature of the main pressing step.

According to the present invention, it has now been found out that cooling the at least one board layer assembly before substantially releasing the pressing pressure, i.e. while the at least on the board layer assembly is still kept pressed substantially with the main pressing pressure, the properties of the at least one finishing layer of the produced laminate board can be significantly improved (compared to the approach in which the cooling is conducted after the pressing pressure has been fully released from the board layer assembly). In detail, it has been found out that such procedure prevents water, which is produced during the lamination process, from vaporizing when releasing the pressing pressure from the at least one board layer assembly. Such water vaporizing would result in a roughening of the surface of the finishing layer and a formation of pores on the finishing layer, which results in poorer properties of the finishing layer, such as a lower smoothness and a higher vulnerability to external influences. This is exactly the case in the known prior art methods.

Since, according to the method of the present invention, the at least one board layer assembly is cooled to a pressure release temperature of 90° C. or lower before substantially releasing the pressing pressure, i.e. while the at least on the board layer assembly is still kept pressed substantially with the main pressing pressure, the mentioned water vaporizing can be avoided or largely avoided and thus the properties of the at least one finishing layer of the produced laminate board are significantly improved. In detail, the at least one finishing layer of the laminate board produced with the method according to the present invention has, for example, a low surface roughness, a low glossiness, and a high resistance to scratching. Furthermore, the at least one finishing layer of the produced laminate board can also have, for example, a high resistance to staining (or acid resistance), a high resistance to water vapour (or steam resistance), and high surface quality value, determined with a graphite test for furniture surface (according to DIN 4575:2020-11). A low surface roughness results in a smooth surface and a low glossiness corresponds to a high mattness of the finishing layer of the produced laminate board. Therefore, the finishing layer of the produced laminate board has also an anti-finger-print effect, which means that fingerprints are (nearly) invisible on the surface. Furthermore, a high surface quality value, determined with a graphite test for furniture surface, indicates that the at least one finishing layer of the produced laminate board has a nearly closed surface with only less pores. This nearly closed surface together also contributes to the high resistances of the the at least one finishing layer of the produced laminate board. Furthermore, the nearly closed surface in combination with the high smoothness results in an easy-to-clean surface of the at least one finishing layer of the produced laminate board.

Thus, due to the specific cooling step, in which the at least one pressed board layer assembly is cooled from the main pressing step temperature to a pressure release temperature of 90° C. or lower while keeping the at least one pressed board layer assembly pressed substantially with the main pressing pressure, the at least one finishing layer of the produced laminate board can, for example, have an extremely homogenous, very smooth surface with a very small amount of pores.

A preferred embodiment of the method according to the present invention is characterized in that
the main pressing pressure is in the range from 1200 kPa to 2500 kPa, preferably from 1500 kPa to 2000 kPa, more preferably from 1600 kPa to 1900 kPa, in particular from 1670 kPa to 1890 kPa, and/or
the main pressing step temperature is in the range from 100° C. to 200° C., preferably from 120° C. to 150° C., more preferably from 130° C. to 140° C., and/or
the pressure release temperature (or cooling step temperature) is in the range from 0° C. to 90° C., preferably from 5° C. to 70° C., more preferably from 10° C. to 50° C., even more preferably from 15° C. to 40° C., in particular from 25° C. to 30° C., e.g. ambient temperature.

By reducing the pressure release temperature, water vaporizing when releasing pressing pressure from the at least one board layer assembly can be avoided to an even greater extent or can be avoided even completely, so that the properties of the at least one finishing layer of the produced laminate board can be further improved.

A further preferred embodiment of the method according to the present invention is characterized in that, between step b) and step c), the at least one board layer assembly is subjected to at least one pre-pressing step in which the at least one board layer assembly is pressed with a pre-pressing pressure at a pre-pressing step temperature, wherein preferably the main pressing pressure is higher than the pre-pressing pressure and/or the main pressing step temperature is higher than the pre-pressing step temperature.

A further preferred embodiment of the method according to the present invention is characterized in that
the pre-pressing pressure is in the range from 800 kPa to 1200 kPa, preferably from 1000 kPa to 1100 kPa, more preferably from 1040 kPa to 1050 kPa, and/or
the pre-pressing step temperature is in the range from 50° C. to 130° C., preferably from 70° C. to 110° C., more preferably from 85° C. to 95° C., and/or
the at least one pre-pressing step has a duration in the range from 30 s to 10 min, preferably from 2 min to 4 min.

A further preferred embodiment of the method according to the present invention is characterized in that the at least one board is selected from the group consisting of particle boards; fibreboards, preferably medium-density fibreboards, high-density fibreboards; and combinations thereof.

A further preferred embodiment of the method according to the present invention is characterized in that the at least one décor layer is at least one décor paper which preferably comprises at least one melamine resin and/or at least one urea resin.

A further preferred embodiment of the method according to the present invention is characterized in that the at least one finishing layer (or the at least one precursor for the at least one finishing layer) comprises or consists of
at least one (polymer) foil or film, preferably comprising or consisting of at least one material selected from the group consisting of acrylic resins; polyvinylchloride; polyesters (e.g. polyethylene terephthalate); polyolefins (e.g. polyethylene, polypropylene); and also mixtures and combinations thereof, and/or
at least one lacquer (layer), preferably comprising or consisting at least one lacquer selected from the group consisting of acrylic lacquers, epoxy resin lacquers, polyurethane lacquers, alkyd resin lacquers, nitrocellulose lacquers, natural resin lacquers, water-based lacquers, and also mixtures and combinations thereof, and/or
at least one varnish (layer), preferably comprising or consisting of at least one varnish selected from the group consisting of acrylic varnishes, epoxy resin varnishes, polyurethane varnishes, alkyd resin varnishes, nitrocellulose varnishes, natural resin varnishes, water-based varnishes, and also mixtures and combinations thereof.

A further preferred embodiment of the method according to the present invention is characterized in that the at least one intermediate layer additionally comprises at least one balancing layer (or balance layer), wherein the at least one balancing layer is preferably at least one balancing paper (or balance paper), more preferably at least one balancing paper comprising at least one melamine resin and/or at least one urea resin.

To achieve an extra smooth surface, it is optional to use at least one balancing layer. The paper helps to even out the surface of the baseboards, so the décor layer adheres more evenly to the surface. Preferably, melamine and/or urea resin can be used to produce the balance paper in a similar impregnation process like used for décor papers. For example, the balance papers have a surface weight around 65 g/m².

A further preferred embodiment of the method according to the present invention is characterized in that the sequence of steps c) and d) is repeated one or more times, wherein optionally the (pressing) pressure is released from the at least one cooled board layer assembly before starting a new sequence of steps c) and d).

A further preferred embodiment of the method according to the present invention is characterized in that the at least one main-pressing step has a duration from 3 min to 15 min, preferably from 6 min to 8 min.

A further preferred embodiment of the method according to the present invention is characterized in that the cooling step has a duration from 3 min to 20 min, preferably from 5 min to 15 min, more preferably from 8 to 12 min.

According to a further preferred embodiment of the method according to the present invention, after step b) the rest of the method can be conducted by using a multi-stage press with back cooling as explained in the following. In the press, the upper press plates are fixed, while the lower press plates can be moved in and out of the press. The bottom press plate enters the press with the prepared package (board+at least one intermediate layer+at least one finishing layer) before the press cycle and exits the press after that cycle with the finished laminated matt, smooth and anti-fingerprint surface. The multi storey press can apply the cycle to 16 packages/boards simultaneously. The press plates as well as the packages enter the press with ambient temperature and then the press cycle, preferably consisting of the 5 steps listed in table 1, begins. After that, the finished laminated boards exit the press. In the case, a finishing layer with a carrier foil is used, the carrier foil is peeled off after the exiting of the finished laminate boards. Depending on what kind of décor and paper types are used the duration of cycle step 2, 3 and 4 varies.

TABLE 1
Preferred press cycle

| | | Pressure | Temperature |
|---|---|---|---|
| Cycle step | Activity | [kPa] | [° C.] |
| 1 | Press closing | ~ | 25-30 |
| 2 | Pre-pressing | 1046 | 90 |
| 3 | Main pressing | 1673.6-1882.8 | 130-140 |
| 4 | Re-cooling | 1673.6-1882.8 | 25-30 |
| 5 | Press opening | ~ | 25-30 |

The present invention is also directed to a laminate board comprising
a board comprising wooden material,
at least one intermediate layer comprising at least one décor layer, the at least one intermediate layer being arranged on at least one side of the board, and
at least one finishing layer being arranged on the at least one intermediate layer,
   wherein the at least one finishing layer has a surface roughness, determined according to DIN EN ISO 25178-1-2016-12, of not more than 15 μm, has a resistance to scratching, determined according to DIN EN 14323-2022-02, of at least 0.5, and has a glossiness at an angle of 850, determined according to DIN EN 14323-2022-02, of not more than 10.0 GU.

A preferred embodiment of the laminate board according to the present invention is characterized in that
a surface roughness, determined according to DIN EN ISO 25178-1-2016-12, of not more than 12 μm, preferably not more than 10 μm, more preferably not more than 8 μm, and/or
a resistance to scratching, determined according to DIN EN 14323 2022-02, of at least 1.5, preferably at least 3, more preferably at least 5, most preferably at least 6, and/or
a glossiness at an angle of 20°, determined according to DIN EN 14323-2022-02, of not more than 4.0 GU, preferably not more than 3.0 GU, more preferably not more than 2.5 GU, most preferably not more than 2.0 GU, and/or
a glossiness at an angle of 60°, determined according to DIN EN 14323-2022-02, of not more than 4.0 GU, preferably not more than 3.0 GU, more preferably not more than 2.0 GU, most preferably not more than 1.0 GU, and/or
a glossiness at an angle of 850, determined according to DIN EN 14323-2022-02, of not more than 9.0 GU, preferably not more than 8.0 GU, more preferably not more than 6.5 GU, most preferably not more than 5.0 GU, and/or
an resistance to staining (or acid resistance), determined according to DIN EN 14323-2022-02, of at least 4, more preferably of 5, and/or
a resistance to water vapour (or steam resistance), determined according to DIN EN 14323-2022-02, of at least 4, more preferably of 5, and/or
a surface quality grade, determined with a graphite test for furniture surface according to DIN 4575:2020-11 of at least 3, more preferably of at least 4, most preferably of 5.

A further preferred embodiment of the laminate board according to the present invention is characterized in that the at least one intermediate layer further comprises at least one balancing layer, wherein the at least one balancing layer is preferably at least one balancing paper, more preferably at least one balancing paper comprising at least one melamine resin and/or at least one urea resin.

A further preferred embodiment of the laminate board according to the present invention is characterized in that the laminate board is producible or produced by the method according to the present invention.

A further preferred embodiment of the laminate board according to the present invention is characterized in that the board is selected from the group consisting of particle boards; fibreboards, preferably medium-density fibreboards, high-density fibreboards; and combinations thereof.

A further preferred embodiment of the laminate board according to the present invention is characterized in that the at least one décor layer is at least one décor paper which preferably comprises at least one melamine resin and/or at least one urea resin.

A further preferred embodiment of the laminate board according to the present invention is characterized in that the at least one finishing layer comprises or consists of
at least one (polymer) foil or film, preferably comprising or consisting of at least one material selected from the group consisting of acrylic resins; polyvinylchloride; polyesters (e.g. polyethylene terephthalate); polyolefins (e.g. polyethylene, polypropylene); and also mixtures and combinations thereof, and/or
at least one lacquer (layer), preferably comprising or consisting at least one lacquer selected from the group consisting of acrylic lacquers, epoxy resin lacquers, polyurethane lacquers, alkyd resin lacquers, nitrocellulose lacquers, natural resin lacquers, water-based lacquers, and also mixtures and combinations thereof, and/or
at least one varnish (layer), preferably comprising or consisting of at least one varnish selected from the group consisting of acrylic varnishes, epoxy resin varnishes, polyurethane varnishes, alkyd resin varnishes, nitrocellulose varnishes, natural resin varnishes, water-based varnishes, and also mixtures and combinations thereof.

The present invention will be explained in more detail with reference to the following example without restricting the invention to the specifically shown parameters.

### EXAMPLE 1 (BLACK—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y200: 70 gr, 61% resin content, 100% melamine resin) on one side of the MDF board, applying a balancing paper (0801: 60 gr, 62.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 2. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 140° C. According to cycle step 4, the still pressed board layer assembly is subjected to a cooling step in which the at least one pressed board layer assembly is cooled from the main pressing step temperature (140° C.) to a pressure release temperature of 35° C. while keeping the at least one pressed board layer assembly pressed with the main pressing pressure 1673.6 kPa).

TABLE 2
Press cycle of Example 1

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 140 | 6.5 |
| 4 | (Re-)cooling | 1673.6 | 35 | 10 |
| 5 | Press opening | | 35 | 0.5 |

### EXAMPLE 2 (ANTHRACITE—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y271: 70 gr, 61% resin content, 100% melamine resin) on one side of the MDF board, applying a balancing paper (0801: 60 gr, 62.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 3. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 140° C. According to cycle step 4, the still pressed board layer assembly is subjected to a cooling step in which the at least one pressed board layer assembly is cooled from the main pressing step temperature (140° C.) to a pressure release temperature of 35° C. while keeping the at least one pressed board layer assembly pressed with the main pressing pressure (1673.6 kPa).

TABLE 3
Press cycle of Example 2

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 140 | 6.5 |
| 4 | (Re-)cooling | 1673.6 | 35 | 10 |
| 5 | Press opening | | 35 | 0.5 |

### EXAMPLE 3 (SNOW WHITE—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y105: 100 gr, 57% resin content, 100% melamine resin) on one side of the MDF board, applying a balancing paper (Y116: 75 gr, 59.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 4. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 135° C. According to cycle step 4, the still pressed board layer assembly is subjected to a cooling step in which the at least one pressed board layer assembly is cooled from the main pressing step temperature (135° C.) to a pressure release temperature of 35° C. while keeping the at least one pressed board layer assembly pressed with the main pressing pressure (1673.6 kPa).

TABLE 4
Press cycle of Example 3

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 135 | 7 |
| 4 | (Re-)cooling | 1673.6 | 35 | 10 |
| 5 | Press opening | | 35 | 0.5 |

### EXAMPLE 4 (ICE WHITE—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y107: 100 gr, 57% resin content, 100% melamine resin) on one side of the MDF board, applying a balancing paper (Y116: 75 gr, 59.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 5. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 135° C. According to cycle step 4, the still pressed board layer assembly is subjected to a cooling step in which the at least one pressed board layer assembly is cooled from the main pressing step temperature (135° C.) to a pressure release temperature of 35° C. while keeping the at least one pressed board layer assembly pressed with the main pressing pressure (1673.6 kPa).

TABLE 5
Press cycle of Example 4

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 135 | 7 |
| 4 | (Re-)cooling | 1673.6 | 35 | 10 |
| 5 | Press opening | | 35 | 0.5 |

### EXAMPLE 5 (IVORY—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y348: 87 gr, 58% resin content, 100% melamine resin) on one side of the MDF board, applying a balancing paper (Y116: 75 gr, 59.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 6. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 135° C. According to cycle step 4, the still pressed board layer assembly is subjected to a cooling step in which the at least one pressed board layer assembly is cooled from the main pressing step temperature (135° C.) to a pressure release temperature of 35° C. while keeping the at least one pressed board layer assembly pressed with the main pressing pressure (1673.6 kPa).

TABLE 6
Press cycle of Example 5

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 135 | 7 |
| 4 | (Re-)cooling | 1673.6 | 35 | 10 |
| 5 | Press opening | | 35 | 0.5 |

### EXAMPLE 6 (SLATE GREY—MATT)

An MDF board (18 mm) according to DIN EN 622-5-2010-03 is provided. The board is 100% FSC, IOS-MAT-0003 v15 and CARB Phase 2 certified as well as IOS-MAT-181 v3 compliant.

A board layer assembly is produced by applying a décor paper (FS Y318: 70 gr, 61% resin content, 100% melamine resin) on one side of the MDF board, applying a balancing paper (0801: 60 gr, 62.5% resin content, 65% urea+35% melamine) on the décor paper, and applying a finishing layer (CO 0015 F-L 0 from Company UPCO GmbH) on the balancing paper. The finishing layer is an acrylic layer (or acrylic foil) carried by a PET foil as carrier, wherein the finishing layer is applied on the balancing paper together with the carrier and the carrier is peeled off after application.

The board layer assembly is subjected to a press cycle comprising the cycle steps 1 to 5 as shown in table 7. According to cycle step 2, the board layer assembly is subjected to a pre-pressing step in which the board layer assembly is pressed with a pre-pressing pressure of 1046 kPa at a pre-pressing step temperature 90° C. According to cycle step 3, the board layer assembly is subjected to at least one main pressing step in which the board layer assembly is pressed with a main pressing pressure of 1673.6 kPa at a main pressing step temperature of at least 140° C. According to cycle step 4, the still pressed board layer assembly is subjected to a cooling step in which the at least one pressed board layer assembly is cooled from the main pressing step temperature (140° C.) to a pressure release temperature of 35° C. while keeping the at least one pressed board layer assembly pressed with the main pressing pressure (1673.6 kPa).

TABLE 7
Press cycle of Example 6

| Cycle | | Pressure | Temperature | Time |
|---|---|---|---|---|
| step | Activity | [kPa] | [° C.] | [min] |
| 1 | Press closing | | 35 | 0.5 |
| 2 | Pre-pressing | 1046 | 90 | 3 |
| 3 | Main pressing | 1673.6 | 140 | 6.5 |
| 4 | (Re-)cooling | 1673.6 | 35 | 10 |
| 5 | Press opening | | 35 | 0.5 |

### Benchmark of Product Properties

Several properties of the finishing layers of the produced laminate boards according to Examples 1 to 6 have been determined. The results are shown in table 8 in comparison to the properties of the finishing layers of ten comparative products from the state of the art.

TABLE 8
Properties of the finishing layers of the produced laminate boards according to
Examples 1 to 6 and of comparative products 1 to 10 from the state of the art

| | Surface | Glossiness [GU] at angle | | | Resistance to | | | Graphite |
|---|---|---|---|---|---|---|---|---|
| | Roughness | 20° | 60° | 85° | scratching | staining | water vapour | test |
| Comp. Product 1 | 15 μm | 2.8 | 3.1 | 10.7 | 0.1 | 5 | 4 | 1 |
| Comp. Product 2 | 14 μm | 2.8 | 4.0 | 26.4 | 0.5 | 5 | 5 | 1 |
| Comp. Product 3 | 25 μm | 3.9 | 3.1 | 9.2 | 0.1 | 4 | 5 | 1 |
| Comp. Product 4 | 25 μm | 4.0 | 4.1 | 8.6 | 0.1 | 4 | 5 | 1 |
| Comp. Product 5 | 30 μm | 3.6 | 3.2 | 8.7 | 0.1 | 4 | 5 | 1 |
| Comp. Product 6 | 25 μm | 3.7 | 3.3 | 10.8 | 1.0 | 3 | 5 | 1 |
| Comp. Product 7 | 30 μm | 3.0 | 2.4 | 7.7 | 1.0 | 5 | 5 | 1 |
| Comp. Product 8 | 15 μm | 2.9 | 3.3 | 28.0 | 0.1 | 5 | 3 | 1 |
| Comp. Product 9 | 14 μm | 3.6 | 4.8 | 22.4 | 0.1 | 3 | 5 | 1 |
| Comp. Product 10 | 15 μm | 3.4 | 4.3 | 22.6 | 0.1 | 3 | 5 | 1 |
| Product of Example 1 | 10 μm | 3.0 | 1.8 | 9.0 | 2.0 | 5 | 5 | 5 |
| Product of Example 2 | 10 μm | 2.7 | 1.8 | 8.0 | 2.5 | 5 | 5 | 5 |
| Product of Example 3 | 10 μm | 3.3 | 2.4 | 8.3 | 4.5 | 5 | 5 | 5 |
| Product of Example 4 | 10 μm | 3.5 | 2.9 | 7.3 | 5.0 | 5 | 5 | 5 |
| Product of Example 5 | 10 μm | 2.9 | 2.6 | 8.4 | 5.0 | 5 | 5 | 4 |
| Product of Example 6 | 10 μm | 2.5 | 1.9 | 7.9 | 3.0 | 5 | 4 | 5 |

Comparative product 1 is the laminate board “feelness” from the producer Kronospan, wherein the finishing layer of this laminate board is a PET finishing layer. Comparative product 2 is the laminate board “Avant-garde” from the producer Kronospan, wherein the finishing layer of this laminate board is an acrylic lacquer layer. Comparative product 3 is the laminate board “Optimatt” from the producer Kaindl, wherein the finishing layer of this laminate board is the same finishing layer as used in Examples 1 to 6, i.e. CO 0015 F-L 0 from Company UPCO GmbH. Comparative product 4 is the laminate board “Xtreme matt” from the producer Pfleiderer, wherein the finishing layer of this laminate board is an HPL finishing layer. Comparative product 5 is the laminate board “Aptico” from the producer Funder, wherein the finishing layer of this laminate board is an HPL finishing layer. Comparative product 6 is the laminate board “Perfect Sense Premium Matt” from the producer Egger, wherein the finishing layer of this laminate board is a lacquer layer. Comparative product 7 is the laminate board “Rauvisio noir” from the producer Rehau, wherein the finishing layer of this laminate board is an HPL finishing layer. Comparative product 8 is the laminate board “soft touch super matt—S064” from the producer Gizir, wherein the finishing layer of this laminate board is a PVC finishing layer. Comparative product 9 is the laminate board “soft touch super matt—S020” from the producer Gizir, wherein the finishing layer of this laminate board is a PVC finishing layer. Comparative product 10 is the laminate board “soft touch super matt—S010” from the producer Gizir, wherein the finishing layer of this laminate board is a PVC finishing layer.

In the production methods of all comparative products 1 to 10, the cooling of the board layer assembly (after the main pressing step) is conducted after the pressing pressure has been fully released from the board layer assembly, i.e. the pressing pressure is released when the board layer assembly is still at the high temperature of the main pressing step.

All values for the surface roughness given in table 8 have been determined according to DIN EN ISO 25178-1-2016-12. All values for the glossiness at angle 20° given in table 8, all values for the glossiness at angle 60° given in table 8, and all values for the glossiness at angle 85° given in table 8 have been determined according to DIN EN 14323-2022-02. All values for the resistance to scratching given in table 8, all values for the resistance to staining given in table 8, and all values for the resistance to water vapour given in table 8 have been determined according to DIN EN 14323-2022-02. The values given in the column “Graphite test” in table 8 are surface quality grades which have all been determined with a graphite test for furniture surface according to DIN 4575:2020-11.

As clearly arises from the values given in table 8, the finishing layers of the laminate boards according to Examples 1 to 6 have improved properties compared to the comparative products 1 to 10 from the state of the art:
None of the comparative products can reach the smoothness of the finishing layer of the products according to Examples 1 to 6 (surface roughness of 10 μm). The second best comparative products in terms of roughness reach only a surface roughness of 14 μm, which is significantly rougher than the finishing layers of the products of Examples 1 to 6.
The scratch resistance test and the graphite test of the products of Examples 1 to 6 show much better results than all the other products.
The finishing layers of the products of Examples 1 to 6 all provide a matt and anti-fingerprint finishing layer with an extraordinarily smooth, scratch resistant, and easy to clean surface that has even a high resistance against staining and water vapour. None of the comparative products can provide such combination of outstanding properties.

1.-14. (canceled)

15. A method of producing one or more laminate boards, the method comprising the steps of:
a) providing at least one board comprising wooden material,
b) producing at least one board layer assembly by:
applying at least one intermediate layer comprising at least one decor layer on at least one side of the at least one board and applying at least one finishing layer or at least one precursor for at least one finishing layer on the at least one intermediate layer, or
applying at least one coated or impregnated intermediate layer comprising at least one decor layer on at least one side of the at least one board, the at least one coated or impregnated intermediate layer having a coating or impregnation of at least one finishing layer or at least one precursor for at least one finishing layer,
c) subjecting the at least one board layer assembly to at least one main pressing step in which the at least one board layer assembly is pressed with a main pressing pressure at a main pressing step temperature of at least 100° C., and
d) subjecting the at least one pressed board layer assembly to a cooling step in which the at least one pressed board layer assembly is cooled from the main pressing step temperature to a pressure release temperature of 90° C. or lower while keeping the at least one pressed board layer assembly pressed substantially with the main pressing pressure.

16. The method according to claim 15, wherein:
the main pressing pressure is in the range from 1200 kPa to 2500 kPa, and/or
the main pressing step temperature is in the range from 100° C. to 200° C., and/or
the pressure release temperature is in the range from 0° C. to 90° C.

17. The method according to claim 15, wherein, between step b) and step c), the at least one board layer assembly is subjected to at least one pre-pressing step in which the at least one board layer assembly is pressed with a pre-pressing pressure at a pre-pressing step temperature, wherein preferably the main pressing pressure is higher than the pre-pressing pressure and/or the main pressing step temperature is higher than the pre-pressing step temperature.

18. The method according to claim 17, wherein:
the pre-pressing pressure is in the range from 800 kPa to 1200 kPa, and/or
the pre-pressing step temperature is in the range from 50° C. to 130° C., and/or
the at least one pre-pressing step has a duration in the range from 30 s to 10 min.

19. The method according to claim 15, wherein:
the at least one board is selected from the group consisting of: particle boards;
fibreboards; and, combinations thereof.

20. The method according to claim 15, wherein:
the at least one decor layer is at least one decor paper which comprises at least one melamine resin and/or at least one urea resin.

21. The method according to claim 15, wherein:
the at least one finishing layer or the at least one precursor for the at least one finishing layer comprises:
at least one foil comprising at least one material selected from the group consisting of: acrylic resins; polyvinylchloride; polyesters; polyolefins; and mixtures and combinations thereof, and/or
at least one lacquer layer comprising at least one lacquer selected from the group consisting of: acrylic lacquers, epoxy resin lacquers, polyurethane lacquers, alkyd resin lacquers, nitrocellulose lacquers, natural resin lacquers, water-based lacquers, and mixtures and combinations thereof, and/or
at least one varnish layer comprising at least one varnish selected from the group consisting of: acrylic varnishes, epoxy resin varnishes, polyurethane varnishes, alkyd resin varnishes, nitrocellulose varnishes, natural resin varnishes, water-based varnishes, and mixtures and combinations thereof.

22. The method according to claim 15, wherein:
the at least one intermediate layer comprises at least one balancing layer, wherein the at least one balancing layer is at least one balancing paper comprising at least one melamine resin and/or at least one urea resin.

23. The method according to claim 15, wherein the sequence of steps c) and d) is repeated one or more times, wherein the pressure is released from the at least one cooled board layer assembly before starting a new sequence of steps c) and d).

24. The method according to claim 15, wherein the at least one main-pressing step has a duration from 3 min to 15 min.

25. A laminate board comprising:
a board comprising wooden material,
at least one intermediate layer comprising at least one decor layer, the at least one intermediate layer being arranged on at least one side of the board, and
at least one finishing layer being arranged on the at least one intermediate layer,
wherein the at least one finishing layer has a surface roughness, determined according to DIN EN ISO 25178-1-2016-12, of not more than 15 μm, has a resistance to scratching, determined according to DIN EN 14323-2022-02, of at least 0.5, and has a glossiness at an angle of 85°, determined according to DIN EN 14323-2022-02, of not more than 10.0 GU.

26. The laminate board according to claim 25, wherein the laminate board comprises:
a surface roughness, determined according to DIN EN ISO 25178-1-2016-12, of not more than 12 μm, and/or
a resistance to scratching, determined according to DIN EN 14323-2022-02, of at least 1.5, and/or
a glossiness at an angle of 20°, determined according to DIN EN 14323-2022-02, of not more than 4.0 GU, and/or
a glossiness at an angle of 60°, determined according to DIN EN 14323-2022-02, of not more than 4.0 GU, and/or
a glossiness at an angle of 85°, determined according to DIN EN 14323-2022-02, of not more than 9.0 GU, and/or
an resistance to staining, determined according to DIN EN 14323-2022-02, of at least 4, and/or
a resistance to water vapour, determined according to DIN EN 14323-2022-02, of at least 4, and/or
a surface quality grade, determined with a graphite test for furniture surface according to DIN 4575:2020-11 of at least 3.

27. A laminate board according to claim 25, wherein the at least one intermediate layer further comprises at least one balancing layer, wherein the at least one balancing layer is preferably at least one balancing paper, more preferably at least one balancing paper comprising at least one melamine resin and/or at least one urea resin.

28. A laminate board according to claim 25, wherein the laminate board is producible or produced by the method according to claim 15.
